(19) United States
(12) Patent Application Publication
(10) Pub. No.: US 2022/0156815 A1
(43) Pub. Date: May 19, 2022

(54) METHODS AND SYSTEMS FOR RATING NEW VEHICLES IN AN ONLINE VEHICLE SALES PLATFORM

(71) Applicant: Sandeep AGGARWAL, Gurgaon (IN)

(72) Inventor: Sandeep AGGARWAL, Gurgaon (IN)

(21) Appl. No.: 17/511,574

(22) Filed: Oct. 27, 2021

Related U.S. Application Data
(63) Continuation-in-part of application No. 17/033,890, filed on Sep. 27, 2020, now abandoned.
Application No. 17/033,890 is a continuation-in-part of application No. 17/065,446, filed on Oct. 7, 2020, now abandoned.
(60) Provisional application No. 62/906,098, filed on Sep. 26, 2019.
(60) Provisional application No. 62/906,099, filed on Sep. 26, 2019.
(60) Provisional application No. 62/911,379, filed on Oct. 7, 2019.
(60) Provisional application No. 62/911,377, filed on Oct. 7, 2019.

(51) Int. Cl. G06Q 30/06

(52) U.S. Cl. CPC G06Q 30/0627

(57) ABSTRACT

A method for implementing a implementing an online vehicle marketplace rating system comprising: providing an online vehicle marketplace system; implementing an online vehicle marketplace rating system; providing a rating system designed to evaluate the overall rating of a vehicle on four parameters; and analyzing a vehicle and providing a performance parameter value for each of the four parameters by; obtaining and analyzing the vehicle and provide a safety parameter value, obtaining and analyzing a vehicle comfort parameter value, obtaining and analyzing a vehicle money parameter value, and obtaining and analyzing a vehicle performance parameter.

### CLAIM OF PRIORITY

This application claim priority to and is a continuation in party of U.S. patent application Ser. No. 17/033,890, filed on Sep. 27, 2020, and titled METHODS AND SYSTEMS FOR CREDIT RISK ASSESSMENT FOR USED VEHICLE FINANCING. U.S. patent application Ser. No. 17/033,890 claims priority to U.S. Provisional Patent Application No. 62/906,098, filed on Sep. 26, 2019, and titled CREDIT RISK ASSESSMENT FOR USED VEHICLE FINANCING. U.S. patent application Ser. No. 17/033,890 claims priority to U.S. Provisional Patent Application No. 62/906,099, filed on Sep. 26, 2019, and titled AUTOMATED DEALS EVALUATION AND MANAGEMENT PLATFORM. These applications are hereby incorporate by reference in their entirety.

This application claim priority to and is a continuation in party of U.S. patent application Ser. No. 17/065,446, filed on Oct. 7, 2020, and titled METHODS AND SYSTEMS FOR CREDIT RISK ASSESSMENT FOR USED VEHICLE FINANCING. U.S. patent application Ser. No. 17/065,446 claims priority to U.S. Provisional Patent Application No. 62/911,379, filed on Oct. 7, 2019, and titled METHODS AND SYSTEMS OF IMPLEMENTING A TOKEN TRANSFER FEATURE. U.S. patent application Ser. No. 17/065,446 claims priority to U.S. Provisional Patent Application No. 62/911,377, filed on Oct. 7, 2019, and titled METHODS AND SYSTEMS FOR RATING NEW VEHICLES IN AN ONLINE VEHICLE SALES PLATFORM. These applications are hereby incorporate by reference in their entirety.

### BACKGROUND

Generally, when someone wishes to purchase a used vehicle (e.g. an automobile, etc.), the user can seek the lowest price. Additionally, when selling a used vehicle, the user can seek the highest price possible. It is also a common scenario that when someone is buying a used automobile from an individual seller, the buyer can acquire the used vehicle at a much lower price than buying from an automobile dealer considering the profit margin of the dealer in the transitional transaction. Similarly, when a user is selling a used vehicle, the used vehicle can fetch a better value when the sale is made to an individual buyer than an automobile dealer as the automobile dealer would try and acquire the vehicle at a lower price and add his/her profit margin during the transitional sale. However, individual users may not have the information to maximize their quoted prices to offer their used vehicle at. Additionally, a buying non-professional user may not have sufficient information to determine a reasonable price to purchase a used vehicle.

### SUMMARY OF THE INVENTION

A method for implementing a implementing an online vehicle marketplace rating system comprising: providing an online vehicle marketplace system; implementing an online vehicle marketplace rating system; providing a rating system designed to evaluate the overall rating of a vehicle on four parameters; and analyzing a vehicle and providing a performance parameter value for each of the four parameters by; obtaining and analyzing the vehicle and provide a safety parameter value, obtaining and analyzing a vehicle comfort parameter value, obtaining and analyzing a vehicle money parameter value, and obtaining and analyzing a vehicle performance parameter.

### BRIEF DESCRIPTION OF THE DRAWINGS

FIG. 1 illustrates an example process for implementing an online vehicle marketplace rating system, according to some embodiments.

FIG. 2 illustrates another example process for rating vehicles, according to some embodiments.

FIG. 3 is a block diagram of a sample computing environment that can be utilized to implement various embodiments.

The Figures described above are a representative set and are not an exhaustive with respect to embodying the invention.

### DESCRIPTION

Disclosed are a system, method, and article of manufacture for a rating new vehicles in an online vehicle sales platform. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Example definitions for some embodiments are now provided.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning. Random forests (RF) (e.g. random decision forests) are an ensemble learning method for classification, regression and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Weighted average is the average of values which are scaled by importance. The weighted average of values is the sum of weights times values divided by the sum of the weights.

### EXAMPLE METHODS AND SYSTEMS

An online vehicle marketplace rating can be provided. The rating system can be for new vehicles in the market. These can act as an industry benchmark for four-wheeled vehicle and/or two-wheeler (e.g. a motorcycle) ratings.

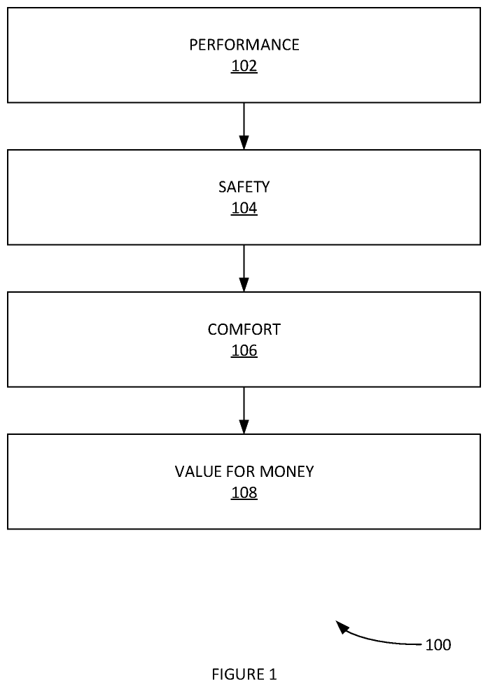

FIG. 1 illustrates an example process 100 for implementing an online vehicle marketplace rating system, according to some embodiments. Process 100 can provide a rating system designed to evaluate the overall rating of a vehicle on four parameters 102-108. In step 102, process 100 can analyze a vehicle and provide a performance parameter value. This can be based on, inter alia, values for the following sub-parameter: power, displacement, torque, number of gears, etc.

In step 104, process 100 can analyze a vehicle and provide a safety parameter value. The safety parameter value can be based on, inter alia, values for sub-parameters: airbags front, airbags rear, ABS, ground clearance, etc. In step 106, process 100 can provide a comfort parameter value. The comfort parameter value can include, inter alia, values for the following sub-parameters: rear AC vent, seats upholstery, automatic climate control, adjustable seats, steering adjustment, cruise control, multi-function steering wheel, folding rear seat, keyless entry, etc. In step 108, process 100 can provide a value for money parameter value. The value for money parameter value can be based on, inter alia, values for the following sub-parameters: mileage, power, displacement, comfort.

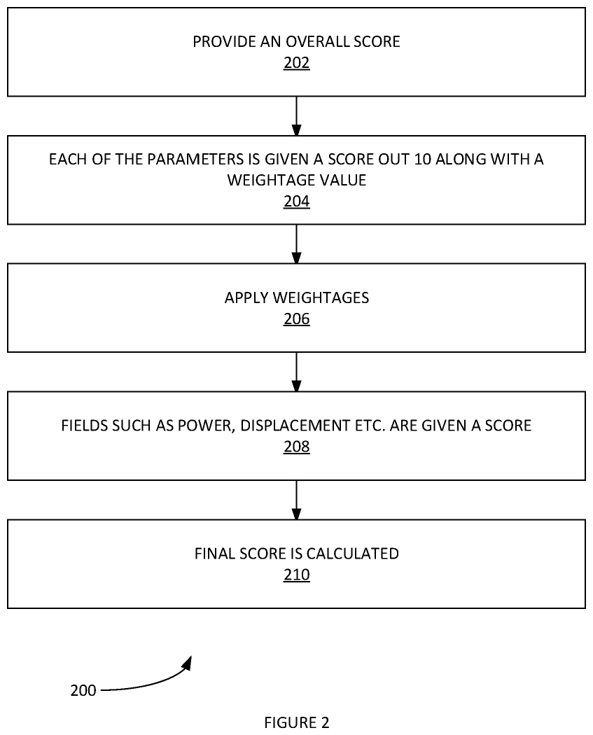

FIG. 2 illustrates another example process 200 for rating vehicles, according to some embodiments. In step 202, process 200 can provide an overall score. The overall score can be is given out of ten (10) points of scale. In step 204, each of the parameters of process 100 (e.g. safety, performance etc.) is given a score out 10 along with a weightage(%) value. The weightages are multiplied with the individual parameters score to obtain the overall score. In step 206, the weightages are applied. In one example, the weightages can be as follows: performance (30%); safety (35%); comfort (20%); value for money (15%). In some examples, machine learning can be utilized to optimize the weightages.

In step 208, the fields such as power, displacement etc. are given a score from 5-9, except for seats upholstery which are rated from 7-9 since there are only three values ‘Vinyl, Fabric and Leather’. In step 210 a final score is calculated. In one example, the following equation can be utilized.

Final Score=performance score*0.3+safety score*0.35+comfort score*0.2+Value for money score*0.15.

### ADDITIONAL EXAMPLE COMPUTER ARCHITECTURE AND SYSTEMS

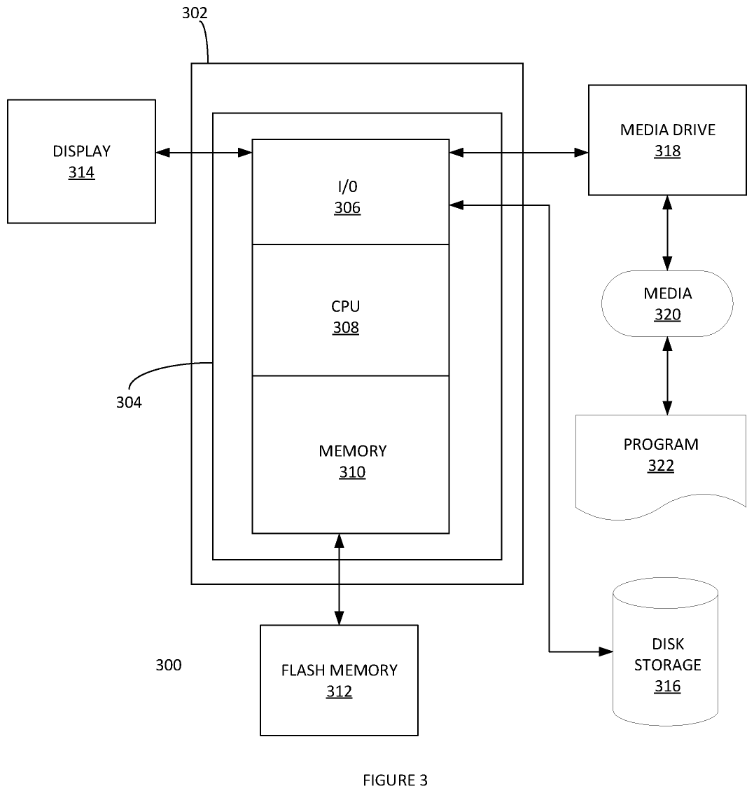

FIG. 3 depicts an exemplary computing system 300 that can be configured to perform any one of the processes provided herein. In this context, computing system 300 may include, for example, a processor, memory, storage, and I/O devices (e.g., monitor, keyboard, disk drive, Internet connection, etc.). However, computing system 300 may include circuitry or other specialized hardware for carrying out some or all aspects of the processes. In some operational settings, computing system 300 may be configured as a system that includes one or more units, each of which is configured to carry out some aspects of the processes either in software, hardware, or some combination thereof.

FIG. 3 depicts computing system 300 with a number of components that may be used to perform any of the processes described herein. The main system 302 includes a motherboard 304 having an I/O section 306, one or more central processing units (CPU) 308, and a memory section 310, which may have a flash memory card 312 related to it. The I/O section 306 can be connected to a display 314, a keyboard and/or other user input (not shown), a disk storage unit 316, and a media drive unit 318. The media drive unit 318 can read/write a computer-readable medium 320, which can contain programs 322 and/or data. Computing system 300 can include a web browser. Moreover, it is noted that computing system 300 can be configured to include additional systems in order to fulfill various functionalities. Computing system 300 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A method for implementing a implementing an online vehicle marketplace rating system comprising:
providing an online vehicle marketplace system;
implementing an online vehicle marketplace rating system;
providing a rating system designed to evaluate the overall rating of a vehicle on four parameters; and
analyzing a vehicle and providing a performance parameter value for each of the four parameters by;
obtaining and analyzing the vehicle and provide a safety parameter value,
obtaining and analyzing a vehicle comfort parameter value,
obtaining and analyzing a vehicle money parameter value, and
obtaining and analyzing a vehicle performance parameter.

2. The method of claim 1, wherein the vehicle performance parameter value comprises a vehicle power parameter.

3. The method of claim 2, wherein the vehicle performance parameter value comprises a vehicle displacement parameter.

4. The method of claim 3, wherein the vehicle performance parameter value comprises a vehicle torque parameter.

5. The method of claim 4, wherein the vehicle performance parameter value comprises a vehicle number of gears parameter.

6. The method of claim 5, wherein the vehicle safety parameter value is based on an airbags front value.

7. The method of claim 6, wherein the vehicle safety parameter value is based on an airbags rear value.

8. The method of claim 7, wherein the vehicle safety parameter value is based on an ABS value.

9. The method of claim 8, wherein the vehicle safety parameter value is based on a ground clearance value.

10. The method of claim 9, wherein the vehicle comfort parameter value is based on a rear AC vent value.

11. The method of claim 10, wherein the vehicle comfort parameter value is based on a seats upholstery value.

12. The method of claim 11, wherein the vehicle comfort parameter value is based on an automatic climate control value.

13. The method of claim 12, wherein the vehicle comfort parameter value is based on an adjustable seats value and a steering adjustment value.

14. The method of claim 12, wherein the vehicle comfort parameter value is based on a cruise control value, a multi-function steering wheel value, a folding rear seat value, and a keyless entry value.

15. The method of claim 14, wherein the vehicle money parameter value is based on a mileage and a power value.

16. The method of claim 14, wherein the vehicle money parameter value is based on a displacement value, and a comfort value.
